(19) United States
(12) Patent Application Publication
(10) Pub. No.: US 2019/0068116 A1
(43) Pub. Date: Feb. 28, 2019

(54) FIBER COMPOSITE PHOTOVOLTAIC BOARD

(71) Applicant: Kai-Yang Syu, Changhua County (TW)

(72) Inventors: Kai-Yang Syu, Changhua County (TW); Chun-Dong Syu, Changhua County (TW)

(21) Appl. No.: 15/820,706

(22) Filed: Nov. 22, 2017

(30) Foreign Application Priority Data
Aug. 25, 2017 (TW) 106128851

(51) Int. Cl. H02S 30/20; H02S 40/38; B32B 5/18; B32B 3/26

(52) U.S. Cl. CPC H02S 30/20; H02S 40/38; B32B 2457/12; B32B 3/26; B32B 5/18

(57) ABSTRACT

A fiber composite photovoltaic board is provided, including: a substrate, a plurality of voids being distributed all over thereinside; at least one photoelectric conversion unit, disposed on the substrate.

### BACKGROUND OF THE INVENTION

### Field of the Invention

The present invention relates to a conversion device, and more particularly to a fiber composite photovoltaic board.

### Description of the Prior Art

As people pay more and more attention to energy issues, environment-friendly and recyclable energies such as solar power are gradually widely used.

To fix a solar panel on a corrugated board, a user needs to arrange a plurality of fixing devices on the corrugated board so as to fix the solar panel. Usually, conventional fixing devices clamp on a plurality of protrusive waves of the corrugated board, but many positions on which the fixing devices clamp are not planes, and may be a curved surface or a truss structure. In addition, the conventional structure has poorer water-proof, heat-insulation and sound-isolation effects.

Besides, the fixing device of a conventional solar panel has more components, so the fixing device is heavy and has a complicated structure, and it is time-consuming and labor-consuming to assemble the fixing device. Especially when a solar system is to be assembled on livestock farming or agricultural equipments, the structural strength of the fixing device is insufficient, so the fixing device cannot provide stable support, and the user has to reinforce a structure of an installation face.

Furthermore, the conventional solar panel and the fixing device thereof can only be arranged on a house roof, but the conventional solar panel and the fixing device thereof cannot be arranged on a building construction member (for example, a tile, a corrugated board or a wall) or a vehicle board members (for example, a car roof).

The present invention has arisen to mitigate and/or obviate the afore-described disadvantages.

### SUMMARY OF THE INVENTION

The major object of the present invention is to provide a fiber composite photovoltaic board, which has light weight, great structural strength, and preferable heat-insulation and sound-isolation effects.

To achieve the above and other objects, a fiber composite photovoltaic board is provided, including a substrate, a plurality of voids being distributed all over thereinside; at least one photoelectric conversion unit, disposed on the substrate.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a first preferred embodiment of the present invention;

FIG. 2 is a side view of the first preferred embodiment of the present invention;

FIG. 3 is a side view of another type of the first preferred embodiment of the present invention;

FIG. 4 is a stereogram of a second preferred embodiment of the present invention;

FIG. 5 is a side view of the second preferred embodiment of the present invention;

FIG. 6 is a side view of another type of the second preferred embodiment of the present invention;

FIG. 7 is a stereogram of a third preferred embodiment of the present invention;

FIG. 8 is a side view of the third preferred embodiment of the present invention;

FIG. 9 is a side view of another type of the third preferred embodiment of the present invention; and

FIG. 10 is a drawing of a fourth preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

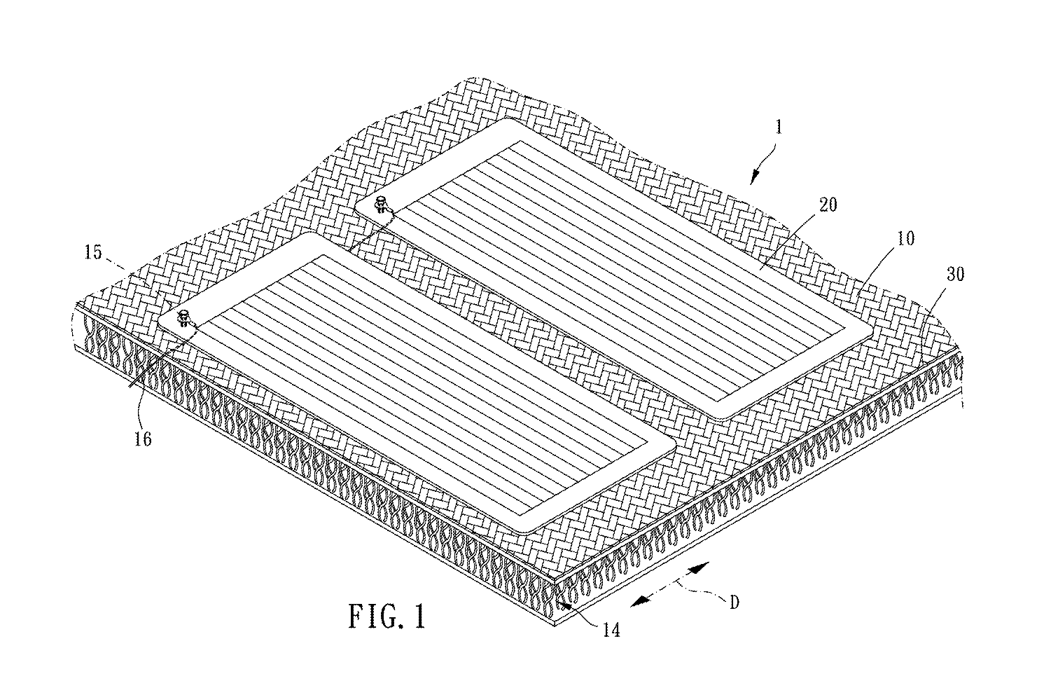

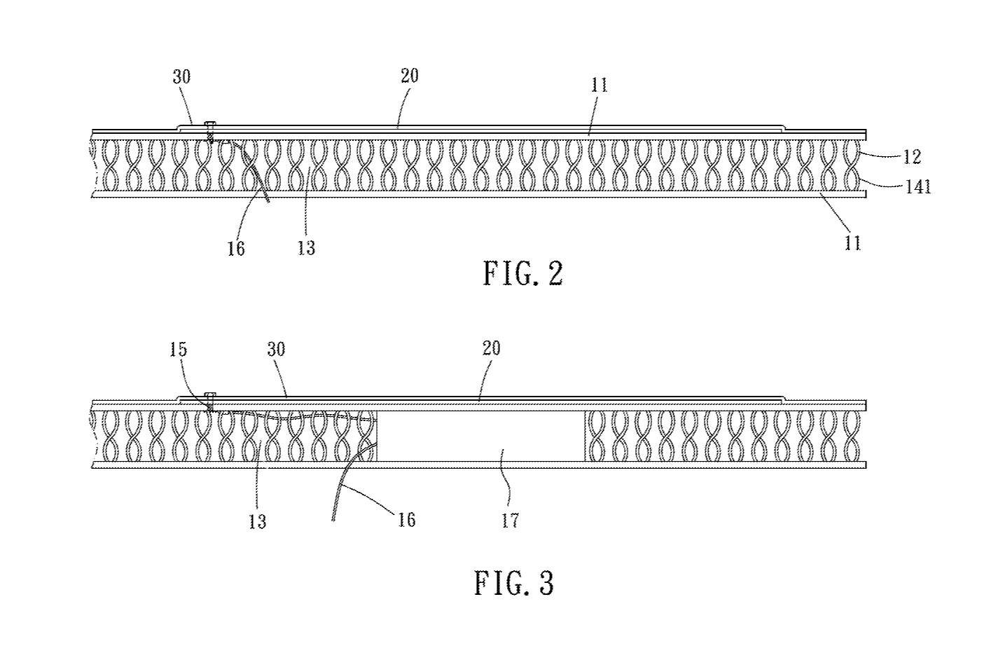

Please refer to FIGS. 1 and 2 for a first preferred embodiment of the present invention. A fiber composite photovoltaic board 1 includes a substrate 10 and at least one photoelectric conversion unit 20. A plurality of voids are distributed all over inside the substrate 10. The at least one photoelectric conversion unit 20 is disposed on the substrate 10; therefore, the fiber composite photovoltaic board 1 has light weight, great structural strength, and preferable heat-insulation and sound-isolation effects. The photoelectric conversion unit 20 may be, for example, a solar panel (monocrystal or polycrystal), and the fiber composite photovoltaic board 1 may be formed as a tile, a corrugated board or a wall in accordance with different application structure modes, the fiber composite photovoltaic board 1 may also be a car roof board or a component of any object. Furthermore, the fiber composite photovoltaic board 1 may also be flexible and change dimension according to different requirements.

In this embodiment, the substrate 10 includes two fiber-reinforced boards 11 and a plurality of fiber-reinforced ribs 12 which are spacingly connected to and between the two fiber-reinforced boards 11, and the plurality of fiber-reinforced ribs 12 define the plurality of voids 13. Fibers in the fiber-reinforced board 11 and the fiber-reinforced rib 12 are, for example, carbon fiber, fiberglass or Kevlar fiber, and a user may choose to use long fibers, short fibers or a combination of the two. A fiber-reinforced composite has light weight and strong structure, and a thickness of the fiber-reinforced composite may be thinned to be 5 mm to 40 mm. Preferably, the plurality of fiber-reinforced ribs 12 and the two fiber-reinforced boards 11 are waved with each other to increase a structural strength. The substrate 10 may be closed, and the plurality of voids 13 may be inflated with at least one of a fire-extinguishing agent or an inert gas. When there is a fire, and the fiber-reinforced board 11 is burned through, the fire-extinguishing agent and the inert gas will be released to contain or extinguish fire.

In this embodiment, the plurality of fiber-reinforced ribs 12 are divided into a plurality of rib sets 14 which are arranged parallel to each other, each fiber-reinforced rib 12 of each said rib set 14 includes at least one lateral curved portion 141, and the lateral curved portion 141 of each of the plurality of the fiber-reinforced ribs 12 of two rib sets 14 which are neighboring to each other bends toward two opposite directions. Specifically, each said fiber-reinforced rib 12 of the rib set 14 bends left and right to be substantially S-shaped, and on a gap direction D of the plurality of rib sets 14, two of the plurality of fiber-reinforced ribs 12 neighboring to each other of two of the plurality of rib sets 14 neighboring to each other are respectively S-shaped and mirrored S-shaped so as to carry and distribute a force evenly to provide a preferable support effect.

One of the two fiber-reinforced boards 11 has at least one electrode terminal 15 which is electrically connected to the photoelectric conversion unit 20. Of course, the user may also use a wire to electrically connect the photoelectric conversion unit 20 from outside of the fiber-reinforced board 11. The plurality of voids 13 between the plurality of fiber-reinforced ribs 12 allow the wire 16 to be disposed therethrough without additional circuit channel, and electricity produced by the photoelectric conversion unit 20 can pass through the wire 16 to export to outside.

The fiber composite photovoltaic board 1 may further include a cover layer 30, and the cover layer 30 may cover the photoelectric conversion unit 20 completely or partly cover a circumference of the photoelectric conversion unit 20 so as to provide sealing, water-proof and protection effects. The cover layer 30 is preferably made of a transparent material so that the cover layer 30 will not decrease photoelectric conversion efficiency, and more preferably, the cover layer 30 may be made of a fire-proof material (for example, a material containing halogen-free flame retardant).

Optionally, at least one power unit 17 which is electrically connected to the electrode terminal 15 of the photoelectric conversion unit 20 is further engaged in the fiber composite photovoltaic board 1 (as shown in FIG. 3) so as to save the electricity produced by the photoelectric conversion unit 20, and there is no need of additional exterior electricity storage equipment. The power unit 17 may be a common battery or a thin film battery.

It is to be noted that the power unit 17 may not only store power but also transfer the power stored to other electronic equipments to charge the electronic equipments, and the power unit 17 may discharge with or without a wire to increase application variety.

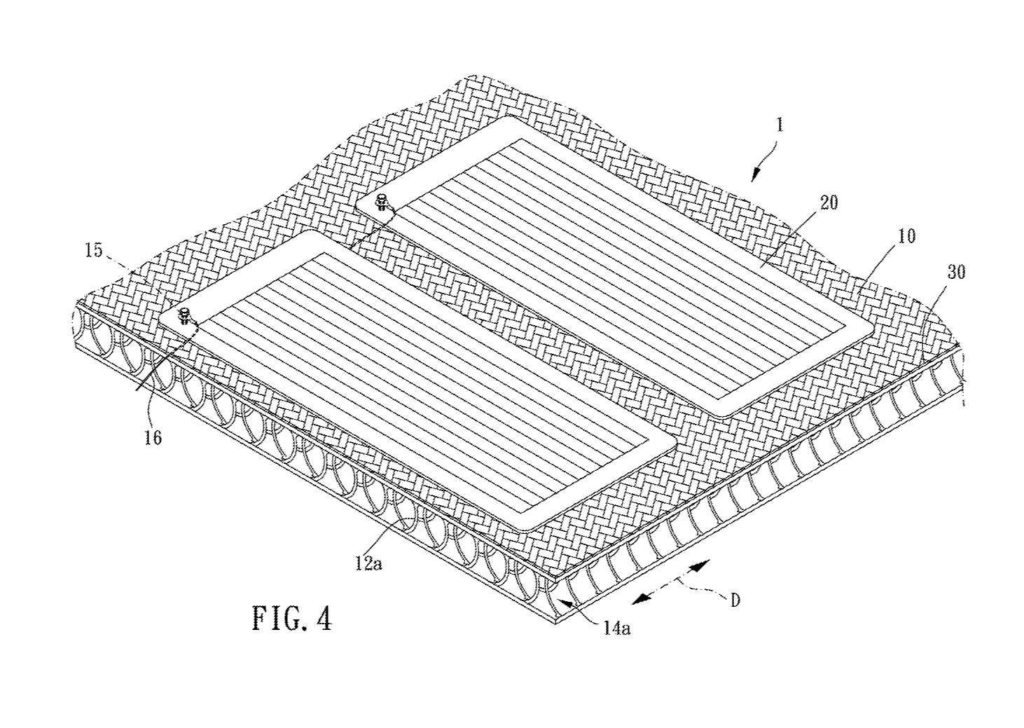

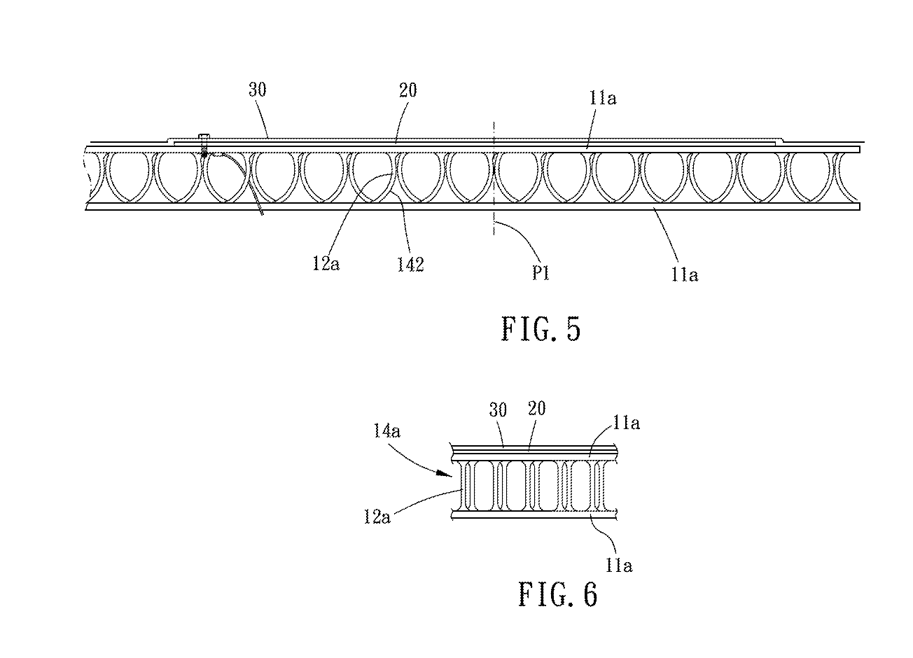

Please refer to FIGS. 4 to 6 for two preferred embodiments of the present invention. Different from the first preferred embodiment, in the two preferred embodiments, each said rib set 14a includes a plurality of fiber-reinforced ribs 12a (has single one said lateral curved portion 142) which bend toward a same direction to elevate a structural strength. On a gap direction D of the plurality of rib sets 14a, two of the plurality of fiber-reinforced ribs 12a neighboring to each other of two of the plurality of rib sets 14a neighboring to each other on two opposite sides of a phantom reference plane P1 extend toward two opposite directions and are connected to and between the two fiber-reinforced boards 11a without crossing the phantom reference plane P1, and the phantom reference plane P1 is perpendicular to an extension direction of the plurality of rib sets 14a so that the structure can carry and distribute a force evenly. The plurality of fiber-reinforced ribs 12a are not interwoven with each other, so each said fiber-reinforce rib 12 can extend smoothly without twist or distortion and can provide a preferable support strength.

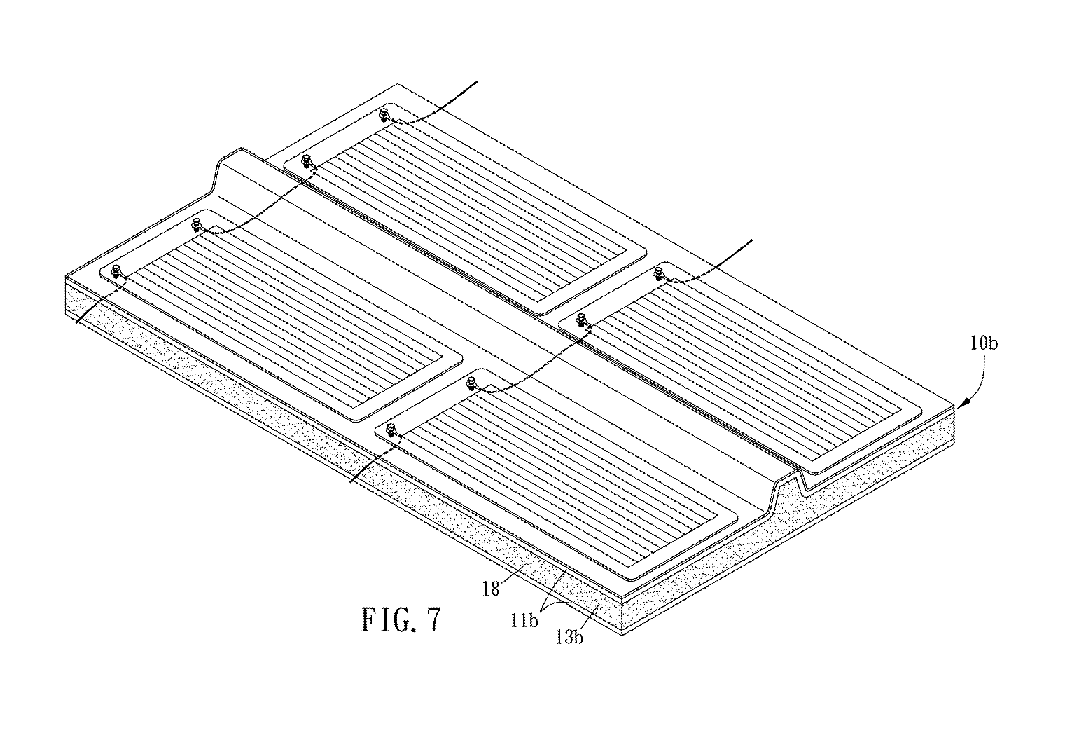

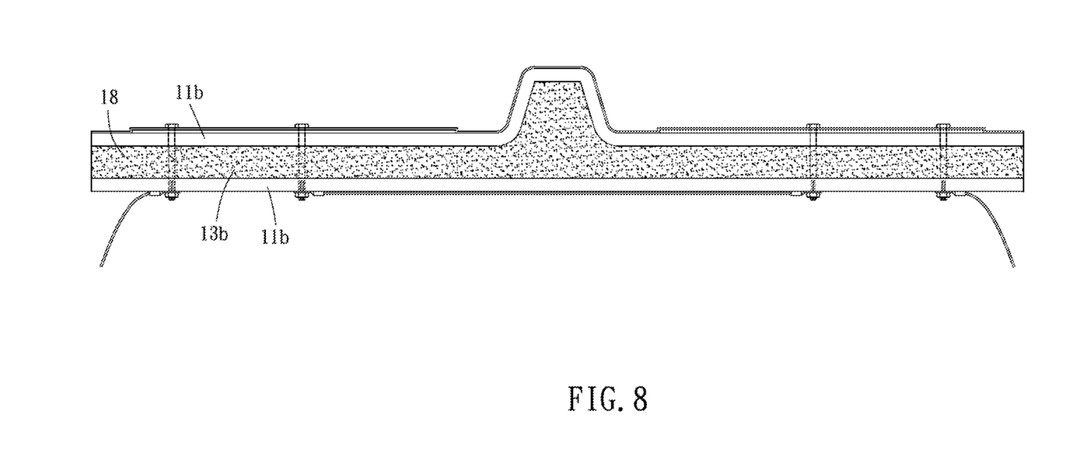

Please refer to FIGS. 7 and 8 for a third preferred embodiment of the present invention. In this embodiment, the substrate 10b includes two fiber-reinforced boards 11b and a plurality of porous layers 18 which are sandwiched between the two fiber-reinforced boards 11b, and the porous layer 18 has the plurality of voids 13b. The porous layer 18 may be a foaming structure, a honeycomb structure, an irregular porous structure or similar porous structures so as to be light-weighted and provide heat-insulation and sound-isolation effects.

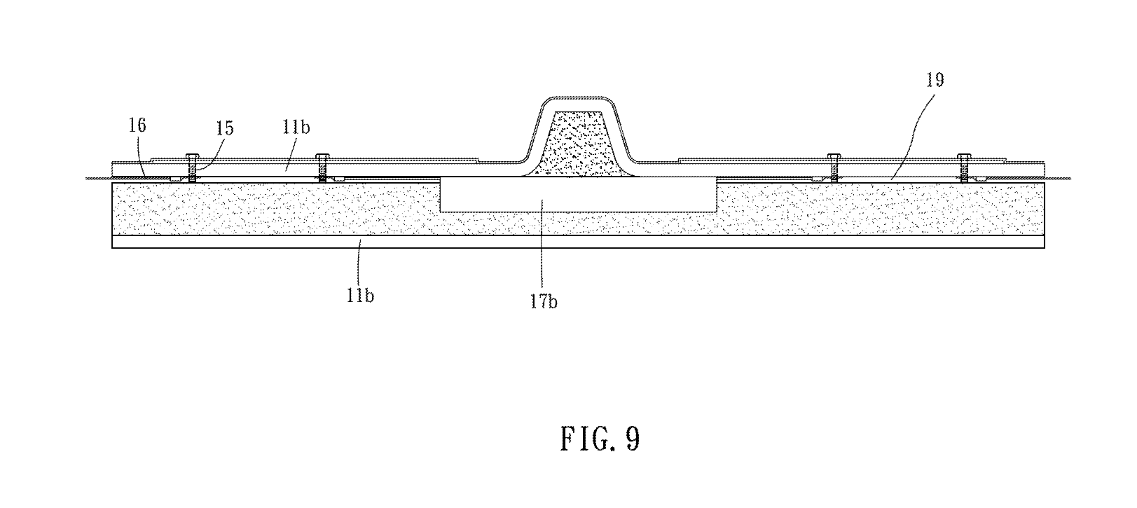

Similarly, at least one power unit 17b which is electrically connected to the electrode terminal 15 of the photoelectric conversion unit 20 is further engaged in the fiber composite photovoltaic board 1, and the wire 16 can be arranged through a passage 19 of the porous layer 18 (as shown in FIG. 9).

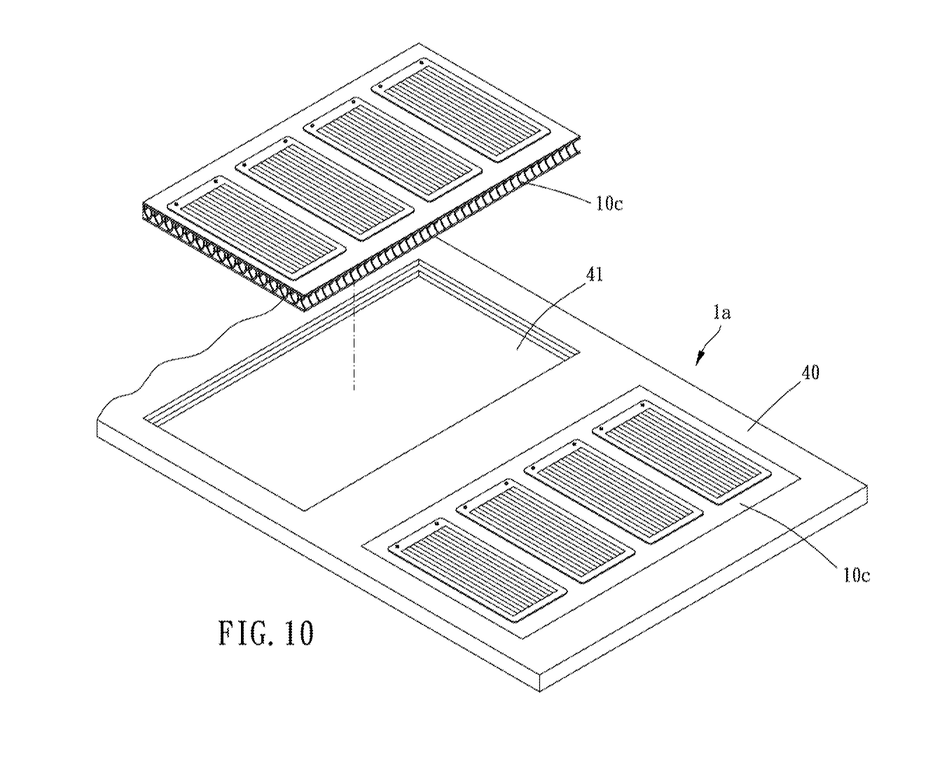

Please refer to FIG. 10 for a fourth preferred embodiment of the present invention. In this embodiment, the fiber composite photovoltaic board 1a further includes a frame body 40, the frame body 40 includes at least one receiving space 41 (at least one will do), and the frame body 40 includes a plurality of rectangular frames each being capable of receiving one said substrate 10c or includes at least one long frame each being capable of receiving a plurality of substrates abuttingly arranged in parallel. The substrate 10c is engaged in the receiving space 41, and the substrate 10c can be modular, so the substrate 10c can be easily and quickly assembled. The frame body 40 can seal (for example, sealingly glued) a circumferential side of the substrate 10c, and the voids of the substrate 10c may be inflated with at least one of a fire-extinguishing agent or an inert gas.

While we have shown and described various embodiments in accordance with the present invention, it should be clear to those skilled in the art that further embodiments may be made without departing from the scope of the present invention.

What is claimed is:

1. A fiber composite photovoltaic board, including:
a substrate, a plurality of voids being distributed all over thereinside;
at least one photoelectric conversion unit, disposed on the substrate.

2. The fiber composite photovoltaic board of claim 1, wherein the substrate further includes two fiber-reinforced boards and a plurality of fiber-reinforced ribs which are spacingly connected to and between the two fiber-reinforced boards, and the plurality of fiber-reinforced ribs define the plurality of voids.

3. The fiber composite photovoltaic board of claim 2, wherein the plurality of fiber-reinforced ribs are divided into a plurality of rib sets which are arranged parallel to each other, each fiber-reinforced rib of each said rib set includes at least one lateral curved portion, and the lateral curved portion of each of the plurality of the fiber-reinforced ribs of two rib sets which are neighboring to each other bends toward two opposite directions.

4. The fiber composite photovoltaic board of claim 3, wherein each said rib set includes a plurality of fiber-reinforced ribs which bend toward a same direction.

5. The fiber composite photovoltaic board of claim 3, wherein on a gap direction of the plurality of rib sets, two of the plurality of fiber-reinforced ribs neighboring to each other of two of the plurality of rib sets neighboring to each other on two opposite sides of a phantom reference plane extend toward two opposite directions and are connected to and between the two fiber-reinforced boards without crossing the phantom reference plane, and the phantom reference plane is perpendicular to an extension direction of the plurality of rib sets.

6. The fiber composite photovoltaic board of claim 1, wherein at least one power unit which is electrically connected to the photoelectric conversion unit is further engaged in the fiber composite photovoltaic board.

7. The fiber composite photovoltaic board of claim 2, wherein one of the two fiber-reinforced boards has at least one electrode terminal which is electrically connected to the photoelectric conversion unit.

8. The fiber composite photovoltaic board of claim 1, wherein the substrate includes two fiber-reinforced boards and a plurality of porous layers which are sandwiched between the two fiber-reinforced boards, and the porous layer has the plurality of voids.

9. The fiber composite photovoltaic board of claim 1, further including a frame body, the frame body including at least one receiving space, the substrate being engaged in the receiving space.

10. The fiber composite photovoltaic board of claim 1, wherein the plurality of voids are inflated with at least one of a fire-extinguishing agent or an inert gas.
